(19) United States
(12) Patent Application Publication
(10) Pub. No.: US 2024/0370485 A1
(43) Pub. Date: Nov. 7, 2024

(54) METHOD AND APPARATUS FOR VECTOR RETRIEVAL, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Chenchang ZHU, Beijing (CN); Jialin FENG, Beijing (CN)

(73) Assignee: BEIJING BAIDU NETCOM SCIENCE TECHNOLOGY CO., LTD., Beijing (CN)

(21) Appl. No.: 18/748,078

(22) Filed: Jun. 19, 2024

(30) Foreign Application Priority Data
May 13, 2024 (CN) 202410592352.4

(51) Int. Cl. G06F 16/435; G06F 16/438

(52) U.S. Cl. CPC G06F 16/435; G06F 16/438

(57) ABSTRACT

The present disclosure provides a vector retrieval method and apparatus, a device and a medium, and relates to the field of artificial intelligence technologies, particularly the fields of cloud computing technologies, big data technologies, or the like. The vector retrieval method includes: acquiring a plurality of candidate vector indexes generated in advance, the plurality of candidate vector indexes being generated based on a plurality of candidate field values included in a target field of original data; acquiring a query vector and a filter condition, the filter condition being used for indicating a condition required to be satisfied by a target vector corresponding to the query vector; if the filter condition includes a target field value required to be satisfied by the target field, determining a target vector index corresponding to the target field value in the plurality of candidate vector indexes; and performing query in the target vector index based on the query vector to obtain the target vector.

The present application claims priority to Chinese Patent Application No. 202410592352.4, entitled “Method and Apparatus for Vector Retrieval, Electronic Device and Storage Medium”, filed on May 13, 2024, the disclosure of which is incorporated herein by reference in its entirety.

### FIELD OF THE DISCLOSURE

The present disclosure relates to the field of artificial intelligence technologies, particularly the fields of cloud computing technologies, big data technologies, or the like, and particularly to a vector retrieval method and apparatus, a device and a medium.

### BACKGROUND OF THE DISCLOSURE

In machine learning and deep learning, data is usually represented in a vector form. A Vector Data Base (VectorDB) is used for storage and query of vectors from vectorization of text, speeches, images, videos, or the like. Compared with a traditional data base, the vector data base can handle more unstructured data (such as images and audios).

The vector data base supports retrieval with filter conditions, and only data records satisfying the filter conditions are retrieved.

### SUMMARY OF THE DISCLOSURE

The present disclosure provides a vector retrieval method and apparatus, a device and a medium.

According to an aspect of the present disclosure, there is provided a vector retrieval method, including: acquiring a plurality of candidate vector indexes generated in advance, the plurality of candidate vector indexes being generated based on a plurality of candidate field values included in a target field of original data; acquiring a query vector and a filter condition, the filter condition being used for indicating a condition required to be satisfied by a target vector corresponding to the query vector; if the filter condition includes a target field value required to be satisfied by the target field, determining a target vector index corresponding to the target field value in the plurality of candidate vector indexes; and performing query in the target vector index based on the query vector to obtain the target vector.

According to another aspect of the present disclosure, there is provided an electronic device, including: at least one processor; and a memory connected with the at least one processor communicatively; wherein the memory stores instructions executable by the at least one processor to enable the at least one processor to perform a vector retrieval method, the vector retrieval method including: acquiring a plurality of candidate vector indexes generated in advance, the plurality of candidate vector indexes being generated based on a plurality of candidate field values included in a target field of original data; acquiring a query vector and a filter condition, the filter condition being used for indicating a condition required to be satisfied by a target vector corresponding to the query vector; if the filter condition includes a target field value required to be satisfied by the target field, determining a target vector index corresponding to the target field value in the plurality of candidate vector indexes; and performing query in the target vector index based on the query vector to obtain the target vector.

According to another aspect of the present disclosure, there is provided a non-transitory computer readable storage medium storing computer instructions, wherein the computer instructions are used for causing a computer to perform a vector retrieval method, the vector retrieval method including: acquiring a plurality of candidate vector indexes generated in advance, the plurality of candidate vector indexes being generated based on a plurality of candidate field values included in a target field of original data; acquiring a query vector and a filter condition, the filter condition being used for indicating a condition required to be satisfied by a target vector corresponding to the query vector; if the filter condition includes a target field value required to be satisfied by the target field, determining a target vector index corresponding to the target field value in the plurality of candidate vector indexes; and performing query in the target vector index based on the query vector to obtain the target vector.

It should be understood that the statements in this section are not intended to identify key or critical features of the embodiments of the present disclosure, nor limit the scope of the present disclosure. Other features of the present disclosure will become apparent from the following description.

### BRIEF DESCRIPTION OF DRAWINGS

The drawings are used for better understanding the present solution and do not constitute a limitation of the present disclosure. In the drawings,

FIG. 1 is a schematic diagram according to a first embodiment of the present disclosure;

FIG. 2 is a schematic diagram of a table within a vector data base in an embodiment of the present disclosure;

FIG. 3 is a schematic diagram of an application scenario for implementing a vector retrieval method according to the embodiment of the present disclosure;

FIG. 4 is a schematic diagram of a candidate vector index in the embodiment of the present disclosure;

FIG. 5 is a schematic diagram according to a second embodiment of the present disclosure;

FIG. 6 is a schematic diagram according to a third embodiment of the present disclosure; and

FIG. 7 is a schematic diagram of an electronic device configured to implement a vector retrieval method according to the embodiment of the present disclosure.

### DETAILED DESCRIPTION OF PREFERRED EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and structures are omitted in the descriptions below.

In the related art, for retrieval with a filter condition, it is necessary to perform a full-table scan to screen records satisfying the filter condition, and then perform retrieval within these records.

A time consumed by the full-table scan is long, and has a high proportion in a whole retrieval process, which influences a retrieval efficiency.

In order to improve the vector retrieval efficiency, the present disclosure provides the following embodiments.

For a better understanding of the embodiments of the present disclosure, the terminology involved in the embodiments of the present disclosure are described below:
Table: a table is one of core concepts in a data base, defines an organization form of data, and includes rows or records of the table, schema details, statistics, or the like.
Statistics: statistics of the table, such as a row number, an occupied storage space, or the like.
Schema: a schema is meta-information describing a form and a behavior of the table, and describes detailed information of the table, such as contained fields, types of scalar indexes built for the fields, types of vector indexes built for the fields, or the like.
Field: a field is also called a column, and in general, the field is not further divided into smaller units (except for a compound type field). One field typically has a plurality of field values.
Index: an index is a special data structure used for quickly searching and accessing data and mainly stored in a memory.
Scalar Index: scalar indexes are various indexes built for scalar fields and used for accelerating accurate query/retrieval based on scalar field values.
Vector Index: vector indexes are various indexes built for vector fields and used for accelerating approximate or violent retrieval based on vector field values.
Filter condition: in vector retrieval, VectorDB supports specifying of a filter parameter in an expression form, so as to ensure that only data records meeting a filter expression condition are retrieved during retrieval in a back-end data base. By supporting the filter condition, fine scalar/vector mixed retrieval of the VectorDB can be realized to support diverse retrieval requirements of various services.

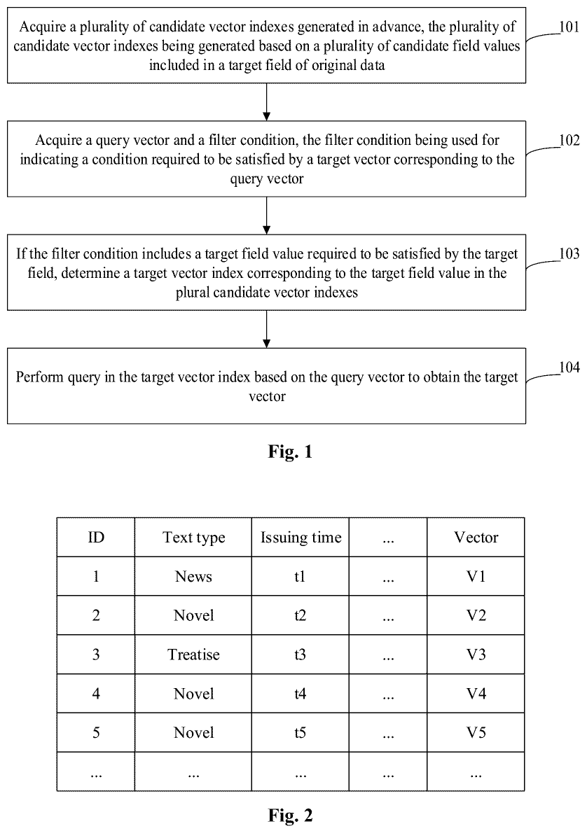

FIG. 1 is a schematic diagram according to a first embodiment of the present disclosure. As shown in FIG. 1, the present embodiment provides a vector retrieval method, including:
101: acquiring a plurality of candidate vector indexes generated in advance, the plurality of candidate vector indexes being generated based on a plurality of candidate field values included in a target field of an original vector;
102: acquiring a query vector and a filter condition, the filter condition being used for indicating a condition required to be satisfied by a target vector corresponding to the query vector;
103: if the filter condition includes a target field value required to be satisfied by the target field, determining a target vector index corresponding to the target field value in the plurality of candidate vector indexes; and
104: performing query in the target vector index based on the query vector to obtain the target vector.

Original data refers to data stored in a data base, and for a vector data base, the original data includes vector data and other fields corresponding to each piece of vector data, and the vector data can be obtained from vectorization of text, speeches, images, videos, or the like. For example, for one image, feature extraction may be performed on the image, and extracted image features may be regarded as one piece of vector data.

The data within the data base is typically organized in the form of tables, each table includes a plurality of rows and a plurality of columns, each row of data may also be referred to as a record, each column may also be referred to as a field, and each field includes a plurality of field values.

For example, as shown in FIG. 2, a table containing text information is shown, one field is “text type”, and the field values under this field include “news”, “novel” and “treatise”; another field is “ID”, and the field values under this field include 1 to 5; another field is “issuing time”, and the field values under this field include t1 to t5; another field is “vector”, and the field values under this field include V1 to V5.

For the sake of distinction, scalar fields of the table are called candidate fields, the above “ID”, “text type”, “issuing time”, or the like, are candidate fields, the field values of the candidate fields are called candidate field values, and the field values “news”, “novel” and “treatise” corresponding to the field “text type” are candidate field values.

The target field refers to one or more fields selected among candidate fields of an enumerated type. The candidate field of the enumerated type means that the field values under the field are enumerable; for example, assuming that the field values of the field “text type” have only the above three types, the above “text type” can be used as the target field.

The candidate vector index refers to a vector index established based on the candidate field values.

For example, if the target field is “text type” which includes the plurality of candidate field values of “news”, “novel”, and “treatise”, one candidate vector index is built based on the original data corresponding to at least one candidate field value. Taking the situation where each candidate field value corresponds to one candidate vector index as an example, a first candidate vector index is established based on the original data corresponding to “news”, a second candidate vector index is established based on the original data corresponding to “novel”, and a third candidate vector index is established based on the original data corresponding to “treatise”, thereby obtaining three candidate vector indexes.

The query vector refers to a vector to be queried, i.e., a vector obtained by vectorizing a query object carried in a query request. For example, if a user needs to retrieve an image, the image serves as the query object, the image may be carried in the query request and sent to a retrieval system, and after receiving the query request, the retrieval system obtains the image from the query request, and performs vectorization (such as image feature extraction) on the image to obtain the query vector.

The target vector refers to a query result which is stored in the data base and matched with the query vector.

The filter condition is used for indicating a condition required to be met by the target vector. For example, if the filter condition indicates that the text type is a novel, vectors corresponding to the novel are required to be screened out, and the target vector is queried in the vectors.

The filter condition carries at least one field and a condition required to be met by the field, and assuming that the field carried in the filter condition includes the target field corresponding to the pre-generated candidate vector index, the condition required to be met by the target field is represented by the target field value required to be met by the target field, and the target field value is one or more of a plurality of candidate field values corresponding to the target field.

For example, if “text type=novel” is included in the filter condition, the target field value is “novel”.

The target vector index is a candidate vector index among the plurality of candidate vector indexes corresponding to the target field value. For example, if the target field value is “novel”, the target vector index is a second vector index based on the above example.

After the target vector index is determined, the target vector matched with the query vector is acquired in the target vector index. For example, based on the above example, query is performed in the second vector index to obtain the target vector without query in all vector indexes (full table).

For example, if the original data has a quantity N=900, and is evenly divided for the candidate field values, the candidate vector index corresponding to “novel” includes 300 records, and compared with scanning of 900 records, scanning of the 300 records can significantly reduce a scanning time, thereby reducing an overall retrieval time and improving a retrieval efficiency.

In the present embodiment, the target vector index is determined from the multiple candidate vector indexes, the query is performed in the target vector index based on the query vector to obtain the target vector, and since the target vector index has a smaller data amount than a full-table vector index, the scanning time can be reduced, and the retrieval efficiency can be improved.

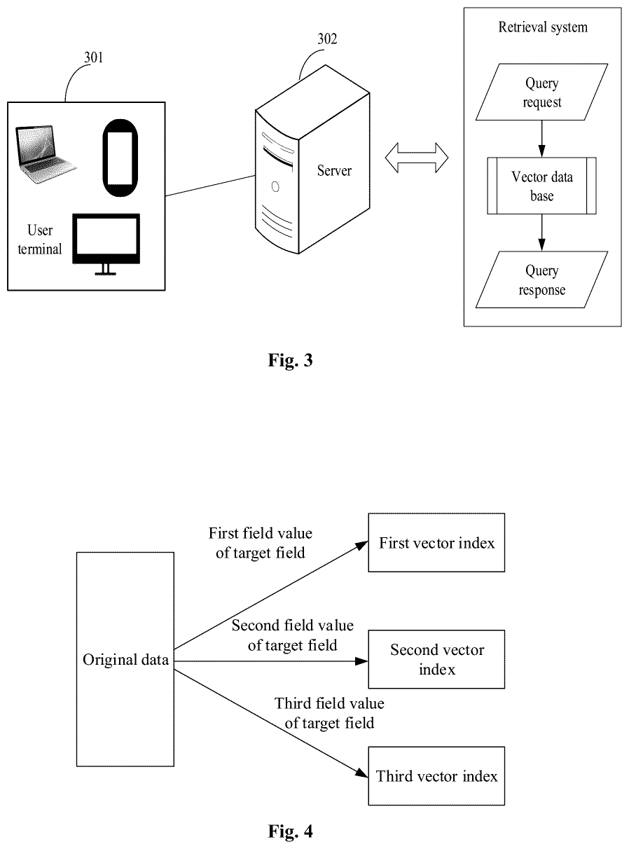

FIG. 3 is a schematic diagram of an application scenario for implementing the vector retrieval method according to the embodiment of the present disclosure.

As shown in FIG. 3, the scenario includes a user terminal 301 and a server 302, and the user terminal 301 may include a personal computer (PC), a mobile device (such as a mobile phone), a tablet computer, a notebook computer, a smart wearable device, or the like. The server 302 may be a cloud server or a local server, and may be a single server or a cluster server. The user terminal 301 and the server 302 may communicate using a communication network including, for example, a wired network and/or a wireless network.

A retrieval application (APP), or called a client, such as a search engine client, a shopping platform client, or the like, may be deployed on the user terminal 301; a server corresponding to the retrieval application may be deployed on the server 302, and the server may be referred to as a retrieval system. The user inputs the query request to the retrieval system through the retrieval APP, and the query request includes the query object (such as a certain image) and the filter condition; after receiving the query request, the retrieval system converts the query object into the query vector; calls the vector data base to obtain the target vector which is matched with the query vector and meets the filter condition; and converts the target vector into the target object (for example, takes the image corresponding to the target vector as the target object), and feeds the target object back to the retrieval APP through a query response, and the target object is displayed to the user through the retrieval APP.

During data base retrieval, in order to accelerate a retrieval process, the vector index may be established in advance, and vector retrieval may be performed based on the vector index. The vector index includes, for example, a flat index, a hierarchical navigable small world (HNSW) index, or the like.

For example, as shown in FIG. 4, for the target field “text type” which has three candidate field values, three candidate vector indexes can be established. Assuming that the candidate field values are represented by a first field value, a second field value, and a third field value respectively, the candidate vector indexes includes a first vector index corresponding to the first field value, a second vector index corresponding to the second field value and a third vector index corresponding to the third field value.

In the above description, as an example, each candidate field corresponds to one candidate vector index, and one candidate vector index may be established based on a plurality of candidate field values; for example, when numbers of the records of “novel” and “treatise” are small, the candidate vector indexes are established based on the corresponding original data of the “novel” and the “treatise”.

In the present embodiment, when one candidate vector index is generated based on each candidate field value, data separation can be realized, the target vector index with a small data amount can be obtained, and the retrieval efficiency can be improved. When one candidate vector index is generated based on a plurality of candidate field values, a plurality of kinds of data can be merged into one candidate vector index to avoid a data skew problem.

Further, a plurality of candidate vector indexes can be established corresponding to a certain target field, and after data is newly inserted into the data base, the data can be inserted into the corresponding candidate vector indexes instead of the whole candidate vector indexes established based on the whole original vectors, thus reducing a change amount and improving a processing efficiency.

After the plurality of candidate vector indexes are generated, in the vector retrieval process, firstly, the target vector index is determined in the plurality of candidate vector indexes according to the target field contained in the filter condition, and then, the query is performed in the target vector index to obtain the target vector. For example, referring to FIG. 4, if the filter condition includes “text type=novel”, the retrieval is performed in the second vector index to obtain the target vector.

Further, in addition to the above-mentioned condition that the target field satisfies the target field value, the filter condition may further include other conditions, such as a condition that the time is earlier than a certain set time point (time<T, T is the set time point), and at this point, the candidate vectors may be obtained in the target vector index according to the other conditions; for example, vectors with times earlier than T are obtained in the second vector index as the candidate vectors, similarity between each candidate vector and the query vector is calculated, and K (K is a set positive integer) candidate vectors with high similarity are selected as the target vectors.

Specifically, the candidate vector may be obtained by constructing a bitmap index.

The bitmap index means that one bit is used to represent a data state, and a dimension is the same as a quantity of data to be scanned. Generally, “1” indicates that data is present and “0” indicates that data is absent. For example, if there are 3 data records, the times of the first and second data records are earlier than the time point T, and the time of the third data record is not earlier than the time point T, the bitmap index=[1, 1, 0] is constructed for the three data records.

Taking the total number of the original vectors N=900 and the number of the vectors corresponding to the target vector index of 300 as an example, it is only necessary to scan 300 records to construct the bitmap index, such that the dimension of the bitmap index is 300, and each element (“1” or “0”) indicates whether the time of the corresponding record is earlier than T.

In the present embodiment, since the bitmap index is constructed based on the target vector index, it is only necessary to scan the 300 records corresponding to the target vector index instead of 900 records, which can save about ⅔ of the scanning time and increase a retrieval speed.

In combination with the application scenario described above, the present disclosure further provides the following embodiments.

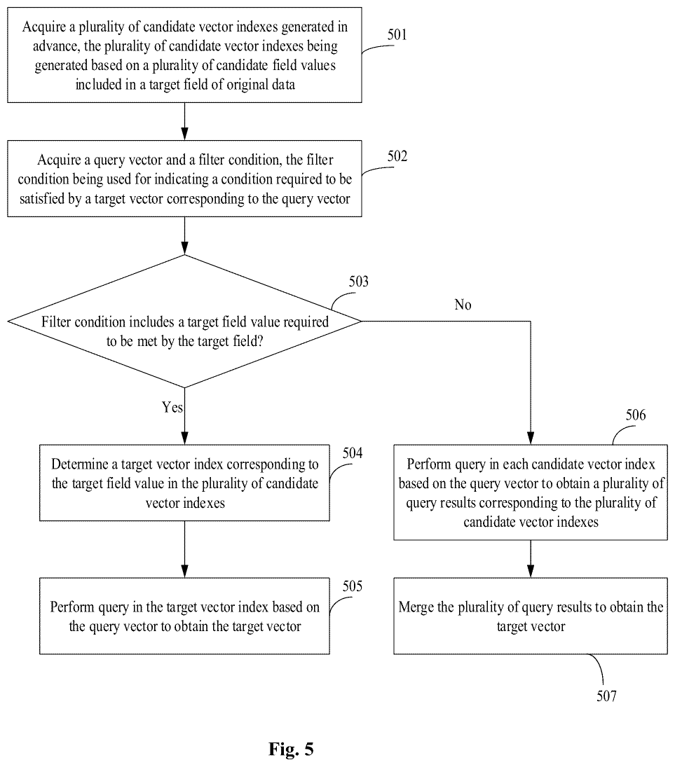

FIG. 5 is a schematic diagram according to a second embodiment of the present disclosure, and the present embodiment provides a vector retrieval method, including:
501: acquiring a plurality of candidate vector indexes generated in advance, the plurality of candidate vector indexes being generated based on a plurality of candidate field values included in a target field of original data.

One candidate vector index may be generated based on an original vector corresponding to each candidate field value; or one candidate vector index may be generated based on the original vectors corresponding to the plurality of candidate field values.

For example, for the target field “text type” which has three candidate field values, three candidate vector indexes can be established. Or, when numbers of records of “novel” and “treatise” are small, one candidate vector index may be established based on the original data corresponding to each of the “novel” and the “treatise”, and thus, two candidate vector indexes are established.

In the present embodiment, when one candidate vector index is generated based on each candidate field value, data separation can be realized, the target vector index with a small data amount can be obtained, and a retrieval efficiency can be improved. When one candidate vector index is generated based on a plurality of candidate field values, a plurality of kinds of data can be merged into one candidate vector index to avoid a data skew problem.

In some embodiments, the method may further include: in response to an insert instruction of a new vector, determining a current field value corresponding to the new vector among the plurality of candidate field values, and inserting the new vector into the candidate vector index corresponding to the current field value.

For example, the new vector is V6, and assuming that the current field value corresponding to the new vector is “news”, based on the above example, the new vector V6 is inserted into the first vector index without changing the second vector index and the third vector index.

In the present embodiment, the new vector is inserted into the candidate vector index corresponding to the current field value, such that a data change amount can be reduced, resource overhead can be saved, and a processing efficiency can be improved.
502: acquiring a query vector and a filter condition, the filter condition being used for indicating a condition required to be satisfied by a target vector corresponding to the query vector.
503: judging whether the filter condition includes a target field value required to be met by the target field, if yes, executing 504 to 505, and if no, executing 506 to 507.

For example, the target field is “text type”, and if the filter condition includes an expression “text type= . . . ”, the filter condition includes the target field value required to be satisfied by the target field; or, if the filter condition does not include information related to “text type”, and the filter condition only expresses “the issuing time is earlier than T”, the filter condition does not include the target field value required to be satisfied by the target field.
504: determining a target vector index corresponding to the target field value in the plurality of candidate vector indexes.
505: performing query in the target vector index based on the query vector to obtain the target vector.

Thereafter, after a new query vector and/or filter condition is obtained, 502 and subsequent steps may be repeated.

In some embodiments, if the filter condition further includes a condition required to be satisfied by another field where the target vector is located, a candidate vector matched with the condition required to be satisfied by the other field is obtained based on the target vector index; and the target vector is obtained based on similarity between the candidate vector and the query vector.

For example, if the filter condition includes “text type-novel, and the issuing time is earlier than T”, vectors with the issuing times earlier than T are obtained as the candidate vectors in the second vector index corresponding to the novel, and then, the similarity between each candidate vector and the query vector is calculated, and K candidate vectors having higher similarity are selected as the target vectors.

In the present embodiment, the candidate vector is obtained in the target vector index based on the condition required to be met by the other field, and then, the target vector is obtained based on the candidate vector, such that the candidate vector can be obtained by searching in a small search space, thus increasing a retrieval speed.

In some embodiments, the target vector index may be scanned based on the condition required to be satisfied by the other field, so as to construct a bitmap index; query is performed in the target vector index based on the bitmap index to obtain the candidate vector.

For example, taking 5 records shown in FIG. 2 as an example, assuming that the issuing times of the records with ID-2 and ID=5 are earlier than T, that is, t2<T, t5<T, and the issuing time of the record with ID=4 is not earlier than T, the bitmap index=[1, 0, 1] may be established, and the candidate vectors are obtained by performing query in the target vector index corresponding to the novel based on the bitmap index; that is, the candidate vectors are V2 and V5. Assuming that the query vector is represented by Q, similarity S1 between Q and V2 and similarity S2 between Q and V5 are calculated, and assuming that K=1 and S1 is greater than S2, V2 is taken as the target vector.

In the present embodiment, the candidate vector is obtained based on the bitmap index, such that the candidate vector can be obtained quickly, thus increasing the retrieval speed; in addition, by performing scanning in the target vector index, the data amount required by scanning can be reduced, thus further increasing the retrieval speed.
506: performing query in each candidate vector index based on the query vector to obtain a plurality of query results corresponding to the plurality of candidate vector indexes.
507: merging the plurality of query results to obtain the target vector.

Thereafter, after a new query vector and/or filter condition is obtained, 502 and subsequent steps may be repeated.

For example, if the filter condition only includes “the issuing time is earlier than T” and does not include the information related to “text type”, query is performed in the first vector index to the third vector index to obtain a first query result, a second query result and a third query result, and then, the first query result, the second query result and the third query result are merged to obtain the target vector.

During the query in each candidate vector index, similar to the query in the target vector index, each candidate vector index is scanned, a bitmap index is established according to the filter condition, the candidate vector in each candidate vector index is obtained according to the bitmap index, and the query result corresponding to each candidate vector index is obtained according to the similarity.

Further, the query in a plurality of candidate vector indexes can be executed in parallel; that is, a plurality of computing nodes can be adopted to perform the query in parallel in the candidate vector indexes based on the query vector, thus further increasing the retrieval speed.

In the present embodiment, when the filter condition does not include the information related to the target field, query is performed in each candidate vector index to obtain the query result, and the query results are merged to obtain the target vector, such that the target vector can be obtained comprehensively and accurately; since a time consumed by the merging operation is negligible, the target vector can be obtained basically without delay or extra overhead.

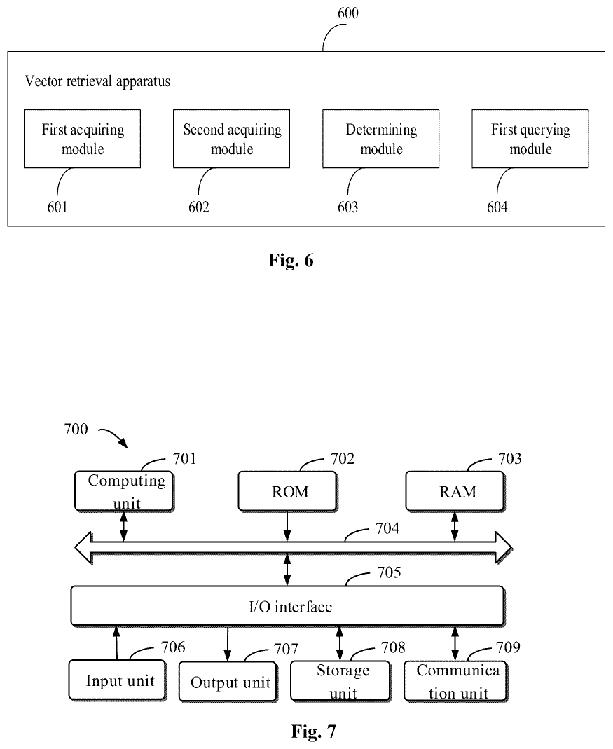

FIG. 6 is a schematic diagram according to a third embodiment of the present disclosure, and the present embodiment provides a vector retrieval apparatus. The apparatus 600 includes: a first acquiring module 601, a second acquiring module 602, a determining module 603 and a first querying module 604.

The first acquiring module 601 is configured to acquire a plurality of candidate vector indexes generated in advance, the plurality of candidate vector indexes being generated based on a plurality of candidate field values included in a target field of original data; the second acquiring module 602 is configured to acquire a query vector and a filter condition, the filter condition being used for indicating a condition required to be satisfied by a target vector corresponding to the query vector; the determining module 603 is configured to, if the filter condition includes a target field value required to be satisfied by the target field, determine a target vector index corresponding to the target field value in the plurality of candidate vector indexes; and the first querying module 604 is configured to perform query in the target vector index based on the query vector to obtain the target vector.

In the present embodiment, the target vector index is determined from the multiple candidate vector indexes, the query is performed in the target vector index based on the query vector to obtain the target vector, and since the target vector index has a smaller data amount than a full-table vector index, a scanning time can be reduced, and a retrieval efficiency can be improved.

In some embodiments, the first querying module is further configured to:
if the filter condition further includes a condition required to be satisfied by another field where the target vector is located, acquire a candidate vector matched with the condition required to be satisfied by the other field based on the target vector index; and acquire the target vector based on similarity between the candidate vector and the query vector.

In the present embodiment, the candidate vector is obtained in the target vector index based on the condition required to be met by the other field, and then, the target vector is obtained based on the candidate vector, such that the candidate vector can be obtained by searching in a small search space, thus increasing a retrieval speed.

In some embodiments, the first querying module is further configured to: scan the target vector index based on the condition required to be satisfied by the other field, so as to construct a bitmap index; perform query in the target vector index based on the bitmap index to obtain the candidate vector.

In the present embodiment, the candidate vector is obtained based on the bitmap index, such that the candidate vector can be obtained quickly, thus increasing the retrieval speed; in addition, by performing scanning in the target vector index, a data amount required by scanning can be reduced, thus further increasing the retrieval speed.

In some embodiments, the apparatus further includes:
a generating module configured to generate one candidate vector index based on the original data corresponding to each candidate field value; or generate one candidate vector index based on the original data corresponding to the plurality of candidate field values.

In the present embodiment, when one candidate vector index is generated based on each candidate field value, data separation can be realized, the target vector index with a small data amount can be obtained, and the retrieval efficiency can be improved. When one candidate vector index is generated based on the plurality of candidate field values, a plurality of kinds of data can be merged into one candidate vector index to avoid a data skew problem.

In some embodiments, the apparatus further includes:
an updating module configured to, in response to an insert instruction of a new vector, determine a current field value corresponding to the new vector among the plurality of candidate field values, and insert the new vector into the candidate vector index corresponding to the current field value.

In the present embodiment, the new vector is inserted into the candidate vector index corresponding to the current field value, such that a data change amount can be reduced, resource overhead can be saved, and a processing efficiency can be improved.

In some embodiments, the apparatus further includes:
a second querying module configured to, if the filter condition does not include the target field value required to be satisfied by the target field, perform query in each candidate vector index based on the query vector to obtain a plurality of query results corresponding to the plurality of candidate vector indexes; and
a merging module configured to merge the plural query results to obtain the target vector.

In the present embodiment, when the filter condition does not include information related to the target field, query is performed in each candidate vector index to obtain the query result, and the query results are merged to obtain the target vector, such that the target vector can be obtained comprehensively and accurately; since a time consumed by the merging operation is negligible, the target vector can be obtained basically without delay or extra overhead.

It may be understood that in the embodiments of the present disclosure, mutual reference may be made to the same or similar contents in different embodiments.

It may be understood that “first”, “second”, or the like, in the embodiments of the present disclosure are only for distinguishing and do not represent an importance degree, a sequential order, or the like.

It is to be understood that, if the sequence of the steps involved in the flow is not specifically described, the time sequence relationship between the steps is not limited.

In the technical solution of the present disclosure, the collection, storage, usage, processing, transmission, provision, disclosure, or the like, of involved user personal information are in compliance with relevant laws and regulations, and do not violate public order and good customs.

According to the embodiment of the present disclosure, there are also provided an electronic device, a readable storage medium and a computer program product.

FIG. 7 shows a schematic block diagram of an exemplary electronic device 700 which may be configured to implement the embodiment of the present disclosure. The electronic device 700 is intended to represent various forms of digital computers, such as laptop computers, desktop computers, workstations, servers, blade servers, mainframe computers, and other appropriate computers. The electronic device may also represent various forms of mobile apparatuses, such as personal digital assistants, cellular telephones, smart phones, wearable devices, and other similar computing apparatuses. The components shown herein, their connections and relationships, and their functions, are meant to be exemplary only, and are not meant to limit implementation of the present disclosure described and/or claimed herein.

As shown in FIG. 7, the electronic device 700 includes a computing unit 701 which may perform various appropriate actions and processing operations according to a computer program stored in a read only memory (ROM) 702 or a computer program loaded from a storage unit 708 into a random access memory (RAM) 703. Various programs and data necessary for the operation of the electronic device 700 may be also stored in the RAM 703. The computing unit 701, the ROM 702, and the RAM 703 are connected with one other through a bus 704. An input/output (I/O) interface 705 is also connected to the bus 704.

The plural components in the electronic device 700 are connected to the I/O interface 705, and include: an input unit 706, such as a keyboard, a mouse, or the like; an output unit 707, such as various types of displays, speakers, or the like; the storage unit 708, such as a magnetic disk, an optical disk, or the like; and a communication unit 709, such as a network card, a modem, a wireless communication transceiver, or the like. The communication unit 709 allows the electronic device 700 to exchange information/data with other devices through a computer network, such as the Internet, and/or various telecommunication networks.

The computing unit 701 may be a variety of general and/or special purpose processing components with processing and computing capabilities. Some examples of the computing unit 701 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 701 performs the methods and processing operations described above, such as the vector retrieval method. For example, in some embodiments, the vector retrieval method may be implemented as a computer software program tangibly contained in a machine readable medium, such as the storage unit 708. In some embodiments, part or all of the computer program may be loaded and/or installed into the electronic device 700 via the ROM 702 and/or the communication unit 709. When the computer program is loaded into the RAM 703 and executed by the computing unit 701, one or more steps of the vector retrieval method described above may be performed. Alternatively, in other embodiments, the computing unit 701 may be configured to perform the vector retrieval method by any other suitable means (for example, by means of firmware).

Various implementations of the systems and technologies described herein above may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input apparatus, and at least one output apparatus.

Program codes for implementing the method according to the present disclosure may be written in any combination of one or more programming languages. These program codes may be provided to a processor or a controller of a general purpose computer, a special purpose computer, or other programmable data processing apparatuses, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input for the computer. Other kinds of apparatuses may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server, also called a cloud computing server or a cloud host, and is a host product in a cloud computing service system, so as to overcome the defects of high management difficulty and weak service expansibility in conventional physical host and virtual private server (VPS) service. The server may also be a server of a distributed system, or a server incorporating a blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A vector retrieval method, comprising:
acquiring a plurality of candidate vector indexes generated in advance, the plurality of candidate vector indexes being generated based on a plurality of candidate field values comprised in a target field of original data;
acquiring a query vector and a filter condition, the filter condition being used for indicating a condition required to be satisfied by a target vector corresponding to the query vector;
if the filter condition comprises a target field value required to be satisfied by the target field, determining a target vector index corresponding to the target field value in the plurality of candidate vector indexes; and
performing query in the target vector index based on the query vector to obtain the target vector.

2. The method according to claim 1, wherein the performing query in the target vector index based on the query vector to obtain the target vector comprises:
if the filter condition further comprises a condition required to be satisfied by another field where the target vector is located, acquiring a candidate vector matched with the condition required to be satisfied by the other field based on the target vector index; and
acquiring the target vector based on similarity between the candidate vector and the query vector.

3. The method according to claim 2, wherein the acquiring a candidate vector matched with the condition required to be satisfied by the other field based on the target vector index comprises:
scanning the target vector index based on the condition required to be satisfied by the other field, so as to construct a bitmap index; and
performing query in the target vector index based on the bitmap index to obtain the candidate vector.

4. The method according to claim 1, further comprising:
generating one candidate vector index based on the original data corresponding to each candidate field value; or
generating one candidate vector index based on the original data corresponding to the plurality of candidate field values.

5. The method according to claim 1, further comprising:
in response to an insert instruction of a new vector, determining a current field value corresponding to the new vector among the plurality of candidate field values, and inserting the new vector into the candidate vector index corresponding to the current field value.

6. The method according to claim 1, further comprising:
if the filter condition does not comprise the target field value required to be satisfied by the target field, performing query in each candidate vector index based on the query vector to obtain a plurality of query results corresponding to the plurality of candidate vector indexes; and
merging the plurality of query results to obtain the target vector.

7. An electronic device, comprising:
at least one processor; and
a memory connected with the at least one processor communicatively;
wherein the memory stores instructions executable by the at least one processor to enable the at least one processor to perform a vector retrieval method, the vector retrieval method comprising:
acquiring a plurality of candidate vector indexes generated in advance, the plurality of candidate vector indexes being generated based on a plurality of candidate field values comprised in a target field of original data;
acquiring a query vector and a filter condition, the filter condition being used for indicating a condition required to be satisfied by a target vector corresponding to the query vector;
if the filter condition comprises a target field value required to be satisfied by the target field, determining a target vector index corresponding to the target field value in the plurality of candidate vector indexes; and
performing query in the target vector index based on the query vector to obtain the target vector.

8. The electronic device according to claim 7, wherein the performing query in the target vector index based on the query vector to obtain the target vector comprises:
if the filter condition further comprises a condition required to be satisfied by another field where the target vector is located, acquiring a candidate vector matched with the condition required to be satisfied by the other field based on the target vector index; and
acquiring the target vector based on similarity between the candidate vector and the query vector.

9. The electronic device according to claim 8, wherein the acquiring a candidate vector matched with the condition required to be satisfied by the other field based on the target vector index comprises:
scanning the target vector index based on the condition required to be satisfied by the other field, so as to construct a bitmap index; and
performing query in the target vector index based on the bitmap index to obtain the candidate vector.

10. The electronic device according to claim 7, wherein the vector retrieval method further comprises:
generating one candidate vector index based on the original data corresponding to each candidate field value; or generating one candidate vector index based on the original data corresponding to the plurality of candidate field values.

11. The electronic device according to claim 7, wherein the vector retrieval method further comprises:
in response to an insert instruction of a new vector, determining a current field value corresponding to the new vector among the plurality of candidate field values, and inserting the new vector into the candidate vector index corresponding to the current field value.

12. The electronic device according to claim 7, wherein the vector retrieval method further comprises:
if the filter condition does not comprise the target field value required to be satisfied by the target field, performing query in each candidate vector index based on the query vector to obtain a plurality of query results corresponding to the plurality of candidate vector indexes; and
merging the plurality of query results to obtain the target vector.

13. A non-transitory computer readable storage medium with computer instructions stored thereon, wherein the computer instructions are used for causing a computer to perform a vector retrieval method, the vector retrieval method comprising:
acquiring a plurality of candidate vector indexes generated in advance, the plurality of candidate vector indexes being generated based on a plurality of candidate field values comprised in a target field of original data;
acquiring a query vector and a filter condition, the filter condition being used for indicating a condition required to be satisfied by a target vector corresponding to the query vector;
if the filter condition comprises a target field value required to be satisfied by the target field, determining a target vector index corresponding to the target field value in the plurality of candidate vector indexes; and
performing query in the target vector index based on the query vector to obtain the target vector.

14. The non-transitory computer readable storage medium according to claim 13, wherein the performing query in the target vector index based on the query vector to obtain the target vector comprises:
if the filter condition further comprises a condition required to be satisfied by another field where the target vector is located, acquiring a candidate vector matched with the condition required to be satisfied by the other field based on the target vector index; and
acquiring the target vector based on similarity between the candidate vector and the query vector.

15. The non-transitory computer readable storage medium according to claim 14, wherein the acquiring a candidate vector matched with the condition required to be satisfied by the other field based on the target vector index comprises:
scanning the target vector index based on the condition required to be satisfied by the other field, so as to construct a bitmap index; and
performing query in the target vector index based on the bitmap index to obtain the candidate vector.

16. The non-transitory computer readable storage medium according to claim 13, wherein the vector retrieval method further comprises:
generating one candidate vector index based on the original data corresponding to each candidate field value; or
generating one candidate vector index based on the original data corresponding to the plurality of candidate field values.

17. The non-transitory computer readable storage medium according to claim 13, wherein the vector retrieval method further comprises:
in response to an insert instruction of a new vector, determining a current field value corresponding to the new vector among the plurality of candidate field values, and inserting the new vector into the candidate vector index corresponding to the current field value.

18. The non-transitory computer readable storage medium according to claim 13, wherein the vector retrieval method further comprises:
if the filter condition does not comprise the target field value required to be satisfied by the target field, performing query in each candidate vector index based on the query vector to obtain a plurality of query results corresponding to the plurality of candidate vector indexes; and
merging the plurality of query results to obtain the target vector.
